(19) United States
(12) Patent Application Publication
(10) Pub. No.: US 2026/0280765 A1
(43) Pub. Date: Sep. 17, 2026

(54) Dynamic Uplink Modification Using Transmission Time Interval Bundling and Deep Reinforcement Learning

(71) Applicant: Dell Products L.P., Round Rock, TX (US)

(72) Inventors: Medhat Khalifa, 6th of October (EG); Yasser AlEryani, Kanata (CA); Mostafa Mouawad, New Cairo (EG)

(21) Appl. No.: 19/080,273

(22) Filed: Mar. 14, 2025

(51) Int. Cl. H04L 1/08

(52) U.S. Cl. CPC H04L 1/08

(57) ABSTRACT

A system can execute a deep reinforcement learning agent that comprises a reward function based on changes to uplink throughputs, changes to packet error rates, changes to respective call drop rates, and changes to latencies. The system can input currently applicable measurements of the broadband cellular communications with the user equipment that satisfy a real-time criterion into the deep reinforcement learning agent, wherein the deep reinforcement learning agent produces an output that indicates a modification to the broadband cellular communications, and wherein the modification comprises a transmission time interval configuration of the first group of transmission time interval configurations or a layer 1 retransmission strategy of the second group of layer 1 retransmission strategies. The system can apply the modification to the broadband cellular communications, to result in modified broadband cellular communications with the user equipment.

### BACKGROUND

A base station can facilitate broadband cellular communications with user equipment.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can execute a deep reinforcement learning agent, wherein a state space of the deep reinforcement learning agent comprises possible network conditions and possible measurements applicable to a network via which broadband cellular communications with user equipment have been conducted, wherein an action space of the deep reinforcement learning agent comprises a first group of transmission time interval configurations, and a second group of layer 1 retransmission strategies, and wherein a reward function of the deep reinforcement learning agent is based on first respective changes to respective uplink throughputs applicable to communication via the network at respective time steps, second respective changes to respective packet error rates applicable to communication via the network at the respective time steps, third respective changes to respective call drop rates applicable to communication via the network at the respective time steps, and fourth respective changes to respective latencies applicable to communication via the network at the respective time steps. The system can input currently applicable measurements of the broadband cellular communications with the user equipment that satisfy a real-time criterion into the deep reinforcement learning agent, wherein the deep reinforcement learning agent produces an output that indicates a modification to the broadband cellular communications, and wherein the modification comprises a transmission time interval configuration of the first group of transmission time interval configurations or a layer 1 retransmission strategy of the second group of layer 1 retransmission strategies. The system can apply the modification to the broadband cellular communications, to result in modified broadband cellular communications with the user equipment.

An example method can comprise executing, by a system comprising a least one processor that facilitates broadband cellular communications with user equipment via a network, a deep reinforcement learning agent, wherein a state space of the deep reinforcement learning agent comprises possible network conditions and possible measurements, wherein an action space of the deep reinforcement learning agent comprises a first group of transmission time interval configurations, and a second group of layer 1 retransmission strategies, and wherein a reward function of the deep reinforcement learning agent is based on first respective changes to respective uplink throughputs corresponding to the network at respective time steps, second respective changes to respective packet error rates corresponding to the network at the respective time steps, third respective changes to respective call drop rates corresponding to the network at the respective time steps, and fourth respective changes to respective latencies corresponding to the network at the respective time steps. The method can further comprise inputting, by the system, currently applicable measurements corresponding to the broadband cellular communications into the deep reinforcement learning agent, wherein the deep reinforcement learning agent outputs an indication of a modification a transmission time interval configuration of the first group of transmission time interval configurations or a layer 1 retransmission strategy of the second group of layer 1 retransmission strategies. The method can further comprise applying, by the system, the modification to the broadband cellular communications to result in modified broadband cellular communications. The method can further comprise facilitating, by the system, the modified broadband cellular communications with the user equipment.

An example non-transitory computer-readable medium can comprise instructions that, in response to execution, cause a system comprising a processor to perform operations. These operations can comprise executing a deep reinforcement learning agent, wherein a state space of the deep reinforcement learning agent comprises possible network conditions and possible measurements associated with a network usable for broadband cellular communications, wherein an action space of the deep reinforcement learning agent comprises transmission time interval configurations, and layer 1 retransmission strategies, and wherein a reward function of the deep reinforcement learning agent is based on at least one key performance indicator of the broadband cellular communications. These operations can further comprise inputting currently applicable measurements associated with the broadband cellular communications into the deep reinforcement learning agent, wherein the deep reinforcement learning agent produces an output that indicates a modification a transmission time interval configuration of the transmission time interval configurations or a layer 1 retransmission strategy of the layer 1 retransmission strategies. These operations can further comprise, after applying the modification to the broadband cellular communications, resulting in modified broadband cellular communications, enabling the modified broadband cellular communications to occur with user equipment.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate dynamic uplink modification using TTI bundling and deep reinforcement learning (DRL), in accordance with an embodiment of this disclosure;

FIG. 2 illustrates an example of transmission time interval (TTI) bundling, and that can facilitate dynamic uplink modification using TTI bundling and DRL, in accordance with an embodiment of this disclosure;

FIG. 3 illustrates an example message flow within a reinforcement learning system, and that can facilitate dynamic uplink modification using TTI bundling and DRL, in accordance with an embodiment of this disclosure;

FIG. 4 illustrates an example of an objective, and that can facilitate dynamic uplink modification using TTI bundling and DRL, in accordance with an embodiment of this disclosure;

FIG. 5 illustrates an example of a reward function, and that can facilitate dynamic uplink modification using TTI bundling and DRL, in accordance with an embodiment of this disclosure;

FIG. 6 illustrates an example process flow of a policy update, and that can facilitate dynamic uplink modification using TTI bundling and DRL, in accordance with an embodiment of this disclosure;

FIG. 7 illustrates an example process flow of training and deployment, and that can facilitate dynamic uplink modification using TTI bundling and DRL, in accordance with an embodiment of this disclosure;

FIG. 8 illustrates an example process flow that can facilitate dynamic uplink modification using TTI bundling and DRL, in accordance with an embodiment of this disclosure;

FIG. 9 illustrates another example process flow that can facilitate dynamic uplink modification using TTI bundling and DRL, in accordance with an embodiment of this disclosure;

FIG. 10 illustrates another example process flow that can facilitate dynamic uplink modification using TTI bundling and DRL, in accordance with an embodiment of this disclosure; and

FIG. 11 illustrates an example block diagram of a computer operable to execute an embodiment of this disclosure.

### DETAILED DESCRIPTION

### Overview

Where the examples described herein mention specific broadband cellular communication protocols, it can be appreciated that they can be applied to other broadband cellular communication protocols.

The present techniques can be implemented to optimize (or improve, relative to not implementing the present techniques) uplink coverage and reliability for Voice over Long Term Evolution (LTE) (VoLTE) and Voice over New Radio (VoNR) services by leveraging Transmission Time Interval (TTI) bundling, Layer 1 retransmissions, and dynamic configuration through deep reinforcement learning (DRL). It can be appreciated that, where the examples described herein relate to optimizing something, or another superlative, there can be examples where that thing is satisfactorily improved, but not optimized.

The present techniques can integrate real-time measurements such as signal-to-noise ratio (SNR), reference signal received power (RSRP), reference signal received quality (RSRQ), packet error rate (PER), round-trip time (RTT), user mobility, and interference levels to provide a comprehensive view of network state. A DRL agent can dynamically adjust TTI configurations, learning an optimal policy to enhance key performance indicators, including uplink throughput, packet error rate, call drop rate, and latency. By combining DRL techniques like Deep Q-Network (DQN), Proximal Policy Optimization (PPO), and Advantage Actor-Critic (A2C) with simulation-based pre-training and real-time deployment, there can be continuous improvement and robust performance. This holistic approach can enhance VoLTE and VoNR service quality, facilitating a high-quality user experience and operational efficiency.

Expansion of Voice over LTE (VoLTE) and Voice over New Radio (VONR) services can prompt new approaches to ensure reliable and high-quality voice communication, even in challenging network environments. The present techniques can facilitate a hybrid approach that combines Transmission Time Interval (TTI) bundling with Layer 1 retransmissions to enhance uplink coverage. Furthermore, the implementation of a deep reinforcement learning (DRL) system can allow for flexible configuration of TTI durations, adapting to network conditions and improving the overall performance of VoLTE and VoNR services.

TTI bundling generally comprises a technique where the User Equipment (UE) transmits the Physical Uplink Shared Channel (PUSCH) over multiple consecutive subframes, such as in groups of four. This can help to improve the reliability of uplink transmissions, especially in poor signal conditions, by increasing the probability that at least one of the transmissions will be successfully received by the network.

Layer 1 retransmissions generally comprise repeating the transmission of data at the physical layer to increase the effective transmission time. This can aid in ensuring that data packets are successfully received, especially in environments with high interference or weak signal strength. By combining retransmissions with TTI bundling, the present techniques can significantly enhance the coverage and reliability of uplink transmissions.

To maximize the benefits of TTI bundling and Layer 1 retransmissions, the present techniques incorporate a use of a DRL system for dynamically configuring TTI durations. A DRL model can learn and adapt to varying network conditions, providing a flexible and intelligent approach to TTI configuration. This adaptability can ensure optimal performance and coverage for VoLTE and VoNR services, even in fluctuating network environments.

By integrating these approaches, this present techniques can offer a comprehensive solution to the challenges of maintaining high-quality voice communication in wireless networks.

The proliferation of mobile devices and the increasing demand for high-quality voice services has driven advancements in wireless communication technologies. VoLTE and VoNR can be components of mobile networks, providing high-definition voice services over LTE and fifth generation (5G) NR, respectively. However, maintaining reliable uplink coverage can be a challenge, such as in scenarios with poor signal conditions or high interference.

Challenges in uplink coverage can include:
Signal Degradation: In areas with weak signal strength, such as rural or indoor environments, maintaining a stable connection can be difficult.
Interference: High levels of interference from other devices or networks can disrupt uplink transmissions.
Mobility: Movement of the UE, such as in vehicles, can cause rapid changes in signal quality, complicating uplink communication.

Prior approaches to improving uplink coverage include power control, modulation schemes, and error correction techniques. While these approaches can provide incremental improvements, they are generally insufficient to address the most challenging conditions faced by modern networks.

TTI bundling and Layer 1 retransmissions can be utilized for enhancing uplink reliability. TTI bundling can increase a chance of successful transmission by sending the same data over multiple subframes. Layer 1 retransmissions can improve reliability by repeating failed transmissions, thus increasing the effective transmission time.

There can be a need for dynamic configuration. Static configurations of TTI durations can be suboptimal in dynamic network environments. A flexible, adaptive approach can be used to optimize performance under varying conditions. This is where DRL can come into play, offering an approach to dynamically adjust TTI durations based on real-time network feedback.

DRL can combine the strengths of reinforcement learning with deep learning, enabling systems to learn optimal policies for decision-making in complex environments. By applying DRL to TTI configuration, the present techniques can continuously adapt to changing network conditions, ensuring optimal performance and coverage.

In summary, the present techniques ca leverage the strengths of TTI bundling, Layer 1 retransmissions, and DRL to provide a robust approach for enhancing uplink coverage in VoLTE and VoNR services. This integrated approach addresses the problems of prior approaches, and can offer a scalable, adaptive solution for modern wireless networks.

VoLTE and VoNR can provide high-quality voice communication over LTE and 5G NR, respectively. Despite their capabilities, ensuring reliable uplink coverage can be challenging, particularly in scenarios with poor signal conditions, high interference, or rapid changes in network environment due to mobility. These challenges can lead to degraded voice quality, dropped calls, and an overall unsatisfactory user experience.

Specific challenges can include:
Weak Signal Conditions: In environments such as rural areas, indoor locations, or regions with significant physical obstructions, UEs can experience weak signal strength. This can result in higher error rates and lower data throughput, severely impacting voice call quality.
High Interference: In densely populated areas or settings with multiple overlapping networks, interference from other devices can degrade the quality of uplink transmissions. This interference can cause packet loss, delays, and reduced reliability.
Mobility: As users move, especially at high speeds (e.g., in vehicles), the signal quality can fluctuate rapidly. These variations can disrupt the continuity of voice calls, leading to frequent handovers, increased latency, and potential call drops.
Static TTI Configurations: Prior approaches often rely on static configurations for Transmission Time Intervals (TTI), which do not adapt well to changing network conditions. This lack of flexibility can result in suboptimal performance, as the system cannot dynamically adjust to improve coverage and reliability in real-time.

Some prior approaches utilize power control and advanced modulation. With power control, modifying the transmission power can help improve signal quality, but it is often a reactive measure with limited effectiveness under extreme conditions.

Some prior approaches use advanced modulation schemes. These can increase data rates and improve error resilience, but their benefits are also constrained by the fundamental limitations of the physical layer and environmental factors.

Some prior approaches use error correction techniques. Techniques like forward error correction (FEC) can mitigate some transmission errors, but they cannot fully compensate for poor signal conditions or high interference levels. They can also introduce additional overhead, which can impact latency and throughput.

Some prior approaches use error correction or Layer 1 retransmissions. TTI bundling generally involves sending data over multiple consecutive subframes to increase the likelihood of successful transmission. However, without dynamic configuration, it can be that this approach is not optimally effective in all scenarios.

Layer 1 retransmissions can generally involve repeating transmissions, which can improve reliability, but it also increases latency and can lead to inefficiencies if not managed adaptively.

Given these drawbacks with prior approaches, there can be a need for a combined, adaptive approach that can dynamically respond to varying network conditions. This approach can combine the strengths of multiple techniques to maximize uplink coverage and performance.

The present techniques can implement a combined approach that leverages:
TTI Bundling: This can enhance transmission reliability by grouping multiple subframes.
Layer 1 Retransmissions: This can increase effective transmission time through repeated data transmissions.
Deep Reinforcement Learning (DRL): This can provide a flexible and adaptive mechanism for configuring TTI durations based on real-time network conditions.

Benefits of the present techniques can include:
Improved Reliability: By combining TTI bundling and retransmissions, the present techniques can increase the likelihood of successful data transmission, even in poor signal conditions.
Dynamic Adaptation: The DRL system can continuously learn and adapt to the network environment, which can ensure optimal TTI configurations and improving overall performance.
Enhanced Coverage: An integrated approach according to the present techniques can extend the coverage area for VoLTE and VoNR services, providing high-quality voice communication across a wider range of conditions.

The present techniques can address a need for a robust, adaptive solution to enhance uplink coverage in VoLTE and VoNR services. By integrating TTI bundling, Layer 1 retransmissions, and DRL-based dynamic configuration, the present techniques can offer a comprehensive and scalable approach to overcoming the drawbacks of prior approaches and ensuring reliable, high-quality voice communication in modern mobile networks.

The present techniques can incorporate several innovative approaches to optimize uplink coverage and reliability for VoLTE and VoNR services. These innovations can span dynamic configuration, advanced learning algorithms, and the integration of multiple data sources to achieve superior network performance.

Dynamic configuration via deep reinforcement learning (DRL) can incorporate adaptive TTI configuration and intelligent policy learning.

### Adaptive TTI Configuration:

Innovation: The present techniques can employ a DRL agent to dynamically adjust the Transmission Time Interval (TTI) configurations in real-time, based on continuously changing network conditions.
Benefits:
   Real-Time Optimization: This can ensure that the network adapts instantly to fluctuations in user demand, mobility, and interference.
   Enhanced Performance: This can improve uplink throughput, reduces packet error rates, and minimize call drops and latency.

### Intelligent Policy Learning:

Innovation: The DRL agent can learn an optimal policy for TTI configuration by exploring various actions and receiving feedback in the form of rewards, which can be formulated based on key performance indicators (KPIs).
Benefits:
   Self-Learning Capability: The agent can continuously improve its decision-making process through interaction with the network environment.
   Scalability: The learning-based approach can be extended to accommodate new technologies and evolving network requirements.

Advanced measurement integration can incorporate comprehensive measurement collection:
Innovation: The system can integrate a wide range of measurements, including SNR, RSRP, RSRQ, PER, RTT, user mobility, and interference levels, to provide a holistic view of the network state.
Benefits:
   Accurate State Representation: This can enable the DRL agent to make more informed decisions by considering comprehensive network conditions.
   Improved Diagnostics: This can facilitate detailed analysis and troubleshooting of network issues.

Enhanced uplink reliability techniques can incorporate TTI bundling and layer 1 retransmissions:
Innovation: This can combine TTI bundling with Layer 1 retransmissions to enhance the reliability of uplink transmissions, particularly in poor radio conditions.
Benefits:
   Increased Robustness: Bundling and retransmissions can significantly improve the likelihood of successful packet delivery.
   Quality Assurance: This can ensure that high-quality VoLTE and VoNR services even under challenging network conditions.

Reward function design can include a multi-metric reward function:
Innovation: The reward function used by the DRL agent can be designed to reflect improvements in multiple sub-metrics, such as uplink throughput (UT), packet error rate (PER), call drop rate (CDR), and latency (L).
Benefits:
   Balanced Optimization: This can ensure that the agent's actions lead to balanced improvements across critical performance indicators.
   User Experience Focused: This can directly correlate with user experience metrics, ensuring practical and noticeable improvements.

Learning algorithm advancements can include advanced DRL techniques:
Innovation: This can utilize DRL techniques such as Deep Q-Network (DQN), Proximal Policy Optimization (PPO), and Advantage Actor-Critic (A2C) to optimize policy learning.
Benefits:
   Efficient Learning: This can facilitate faster convergence to an optimal policy.
   Robust Performance: This can stability and robustness in the agent's learning process, enhancing overall system reliability.

Deployment and scalability can include simulation-based training and real-time deployment.

### Simulation-Based Training:

Innovation: The DRL agent can be trained in a simulated environment that closely mimics real-world network conditions, allowing it to learn effectively before deployment.
Benefits:
   Risk Mitigation: This can reduce the risk of suboptimal performance during initial deployment by pre-training in a controlled environment.
   Accelerated Deployment: This can speed up the process of bringing the optimized system into live networks.

### Real-Time Deployment:

Innovation: After training, the DRL agent can be deployed in the live network, where it can continuously monitor measurements and adjust TTI configurations in real-time.
Benefits:
   Continuous Improvement: The agent can keep refining its policy based on real-world feedback, leading to ongoing enhancements in network performance.
   Seamless Integration: This can ensure that the system can operate alongside existing network management systems without significant disruptions.

An overall impact can include holistic network optimization:
Innovation: By integrating advanced DRL techniques with comprehensive measurement and robust uplink reliability methods, the present techniques can provide a holistic approach to network optimization.
Benefits:
   Enhanced User Experience: This can result in a noticeable improvement in VoLTE and VoNR service quality for end-users.
   Operational Efficiency: This can streamline network management and reduces the need for manual intervention, leading to lower operational costs.

These innovation points collectively contribute to a significant advancement in the management and optimization of uplink coverage and reliability in LTE and 5G NR networks, ensuring superior performance and user satisfaction relative to prior approaches.

An objective of the present techniques can be to enhance the uplink coverage and reliability for VoLTE and VoNR services. This can be achieved by optimizing key performance indicators (KPIs) through a combined approach of TTI bundling, Layer 1 retransmissions, and dynamic configuration using DRL.

With regard to optimizing KPIs, an KPI to be optimized in this formulation can the uplink coverage and reliability index (UCRI), which can be influenced by the following sub-metrics:
Packet error rate (PER): The ratio of erroneous packets received to the total packets transmitted.
Uplink throughput (UT): The rate at which data is successfully transmitted from the UE to the network.
Latency (L): The time delay experienced in the transmission of packets.
Call drop rate (CDR): The frequency of dropped calls during a voice communication session.

An objective can be to minimize PER and CDR while maximizing UT and controlling L within acceptable limits.

The present techniques can utilize various input measurements to dynamically adjust TTI configurations and optimize the KPI. These measurements can include:
Signal-to-Noise Ratio (SNR): This indicates the quality of the signal received by the UE.
Reference Signal Received Power (RSRP): This measures the received power of the reference signals.
Reference Signal Received Quality (RSRQ): This provides information on the quality of the reference signals received.
Packet Error Rate (PER): This provides real-time measurement of the ratio of erroneous packets.
Round-Trip Time (RTT): This indicates the time taken for a signal to travel from the UE to the network and back.
User Mobility: This indicates the speed and direction of the UE's movement.
Interference Levels: This is a measurement of interference from other devices or networks.
Retransmission Count: This is the number of times a packet is retransmitted.

It can be that an optimization process adheres to certain constraints to ensure feasible and practical implementations. These constraints can include:
Transmission Power Limits: The UE and network can have maximum allowable transmission power levels which are not to be exceeded.
Latency Threshold: It can be that the latency must be kept within acceptable limits to ensure satisfactory voice communication quality.
Bandwidth Constraints: It can be that the available bandwidth must be efficiently utilized without causing excessive congestion or interference.
Regulatory Compliance: This can be adherence to regulatory standards and guidelines for wireless communication.
Resource Allocation: This can be optimal allocation of network resources to balance load and prevent overloads.
QoS Requirements: It can be that quality of service (QoS) parameters must be met to maintain a high user experience.

Given the inputs and constraints, a problem can be formulated as an optimization problem.

An objective can be formulated to maximize the uplink coverage and reliability index (UCRI):

$$Maximize UCRI = α . U T - β . P E R - γ . C D R - δ . L ,$$

where:
α, β, γ, and δ are weighing factors that balance the importance of each sub-metric.
Subject to Constraints:
   Transmission Power Limits: P_{TX}≤Pₘₐₓ
   Latency Threshold: L≤Lₘₐₓ
   Bandwidth Constraints: B_{used}≤B_{available}
   Regulatory Compliance: Compliance with regulatory standards
   Resource Allocation: Efficient allocation of network resources to UEs
   QoS Requirements: QoS parameters met for voice communication.

A Deep Reinforcement Learning model can dynamically adjust the TTI configurations based on real-time input measurements to optimize the KPI. The DRL agent can learn the optimal policy π* that maximizes the expected cumulative reward R, defined as:

$${π}^{*} = arg max \text{?} [ {\sum }_{t = 0}^{T} {r}_{t} ] ,$$

Where:
rₜ is the reward at time step t, which is a function of the KPI.
T is the time horizon.

The state and action space can be as follows:
State Space(S): This is possible network conditions and measurements, including SNR, RSRP, RSRQ, PER, RTT, user mobility, interference levels, and retransmission count.
Action Space (A): This includes possible TTI configurations and Layer 1 retransmission strategies that the agent can choose from.

The reward function rₜ can be designed to reflect the optimization of the UCRI. It can be determined based on the improvements in the sub-metrics (UT, PER, CDR, and L) at each time step:

$${r}_{t} = α . Δ {UT}_{t} - β . Δ PE {R}_{t} - γ . Δ CD {R}_{t} - δ . Δ {L}_{t}$$

where:
ΔUTₜ is the change in uplink throughput at time step t.
ΔPERₜ is the change in packet error rate at time step t.
ΔCDRₜ is the change in call drop rate at time step t.
ΔLₜ is the change in latency at time step t.

The DRL agent can employ a learning technique such as deep Q-network (DQN), proximal policy optimization (PPO), or advantage actor-critic (A2C) to iteratively improve its policy π based on feedback from the environment. The policy can be updated by:
Exploration: Sampling actions from the action space to discover their effects on the state and reward.
Exploitation: Selecting actions that maximize the expected reward based on the learned policy.
Policy Update: Adjusting the policy parameters to improve the expected cumulative reward.

Training and deployment can be implemented as follows:
Training Phase: The DRL agent can be trained in a simulated network environment that mimics real-world conditions. The agent can explore various TTI configurations and learns to optimize the KPI through trial and error.
Deployment Phase: Once trained, the DRL agent can be deployed in the live network. It can continuously monitor the input measurements and dynamically adjust TTI configurations in real-time to maintain optimal uplink coverage and reliability.

Benefits of the present techniques can include:
Adaptive optimization: The DRL system can continuously adapt to changing network conditions, facilitating optimal performance in various scenarios.
Improved performance: By dynamically adjusting TTI configurations, the DRL agent can maximize uplink throughput, minimize packet errors and call drops, and control latency.
Scalability: The approach can scale with the complexity of the network and can be extended to accommodate new technologies and requirements.

A system that implements the present techniques can be as follows. Such a system can aim to enhance the uplink coverage and reliability for Voice over LTE (VoLTE) and Voice over New Radio (VoNR) services by leveraging a combination of Transmission Time Interval (TTI) bundling, Layer 1 retransmissions, and dynamic configuration using Deep Reinforcement Learning (DRL).

Components of an example system include:
User equipment (UE): The mobile devices used by end-users to access VoLTE and VoNR services.
eNodeB/gNodeB: The base stations in LTE (eNodeB) and 5G NR (gNodeB) networks that handle communication with the UE.
Core network: The backbone network that connects the base stations and manages data routing, session management, and other control functions.
DRL agent: The intelligent system that dynamically adjusts the TTI configurations based on real-time network conditions.
Network management system (NMS): A system responsible for monitoring, controlling, and managing the network infrastructure.

Functional blocks of an example system can include:
Measurement collection module: This can gather real-time measurements such as SNR, RSRP, RSRQ, PER, RTT, user mobility, interference levels, and retransmission counts from the UE and base stations.
DRL engine: This can comprise a core of the DRL agent, which processes measurements, makes decisions on TTI configurations, and updates its policy based on feedback.
Configuration management module: This applies the TTI configurations determined by the DRL agent to the network.
Feedback loop: This provides continuous feedback to the DRL agent about the performance of the applied configurations, enabling real-time adjustments.

Technologies used in the present techniques can include:
Transmission time interval (TTI) Bundling: TTI bundling comprises a technique used to enhance the reliability of uplink transmissions in poor radio conditions. By bundling multiple TTIs into a single transmission, the UE can increase the probability of successful packet delivery. This technique can be beneficial for VoLTE and VoNR services, where maintaining a continuous and reliable connection is critical.
Layer 1 Retransmissions: Layer 1 retransmissions refer to the process of retransmitting data at the physical layer if errors are detected. This technique can help improve the reliability of data transmission by allowing multiple attempts to correctly deliver packets. The combination of TTI bundling and Layer 1 retransmissions can ensure higher robustness in uplink communication.
Deep Reinforcement Learning (DRL): DRL comprises a type of machine learning that combines reinforcement learning principles with deep neural networks. The DRL agent can learn to optimize the TTI configurations by exploring various actions and receiving feedback in the form of rewards or penalties. The goal can be to find an optimal policy that maximizes the cumulative reward, which corresponds to the improved uplink coverage and reliability.

Measurement technologies used in the present techniques can include:
Signal-to-noise ratio (SNR): A measure of signal quality that compares the level of the desired signal to the level of background noise.
Reference signal received power (RSRP): Indicates the power level of received reference signals, providing insights into signal strength.
Reference signal received quality (RSRQ): Combines information on signal strength and interference, offering a comprehensive measure of signal quality.
Packet error rate (PER): Tracks the ratio of erroneous packets to the total number of transmitted packets.
Round-trip time (RTT): Measures the time taken for a signal to travel from the UE to the network and back, providing latency information.
User mobility: Monitors the speed and direction of the UE's movement, which affects signal quality and network performance.
Interference levels: Assesses the impact of external signals on the network, critical for optimizing resource allocation.

Network management and configuration can be implemented as follows. A network management system (NMS) can integrate with the DRL agent to facilitate seamless application of TTI configurations. It can ensure that the configurations comply with regulatory standards, maintain QoS requirements, and efficiently utilize available bandwidth and resources.

Communications protocols utilized with the present techniques can include:
LTE/5G NR protocols: For uplink and downlink communication between the UE and the base stations.
Control plane protocols: For signaling and management of network resources and configurations.
Data plane protocols: For data transmission, which can ensure high throughput and low latency.

Integration and deployment of a DRL agent can involve a training phase. The DRL agent can be initially trained in a simulated environment that replicates real-world network conditions. This phase can involve:
Simulation environment: Creating a detailed model of the network to train the DRL agent under various scenarios.
Exploration and exploitation: Allowing the agent to explore different TTI configurations and learn.

This present techniques can facilitate optimizing uplink coverage and reliability for Voice over LTE (VoLTE) and Voice over New Radio (VoNR) services by leveraging Transmission Time Interval (TTI) bundling, Layer 1 retransmissions, and dynamic configuration through Deep Reinforcement Learning (DRL). The present techniques can integrate real-time measurements such as SNR, RSRP, RSRQ, PER, RTT, user mobility, and interference levels to provide a comprehensive view of the network state. A DRL agent dynamically adjusts TTI configurations, learning an optimal policy to enhance key performance indicators, including uplink throughput, packet error rate, call drop rate, and latency. By combining DRL techniques like DQN, PPO, and A2C with simulation-based pre-training and real-time deployment, the present techniques can ensure continuous improvement and robust performance. This holistic approach can enhance VoLTE and VoNR service quality, providing a superior user experience and operational efficiency.

### Example Architecture, Etc.

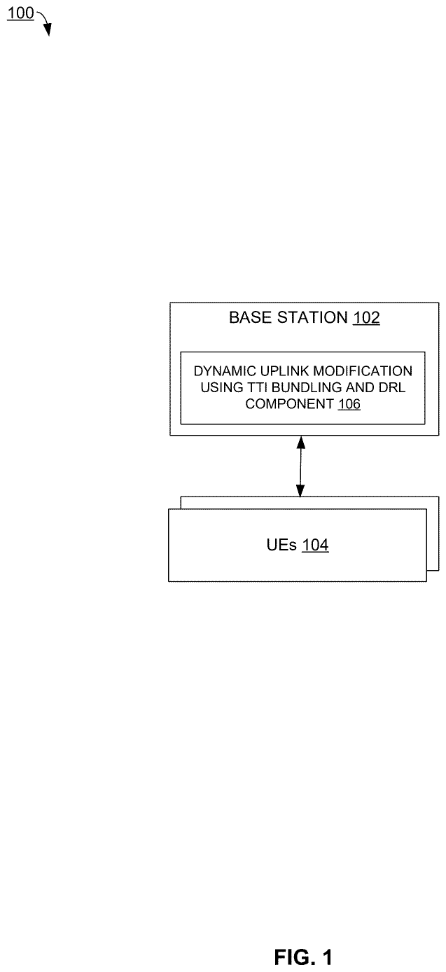

FIG. 1 illustrates an example system architecture 100 that can facilitate dynamic uplink modification using TTI bundling and DRL, in accordance with an embodiment of this disclosure.

System architecture 100 comprises base station 102, UE(s) 104, and dynamic uplink modification using TTI bundling and DRL component 106.

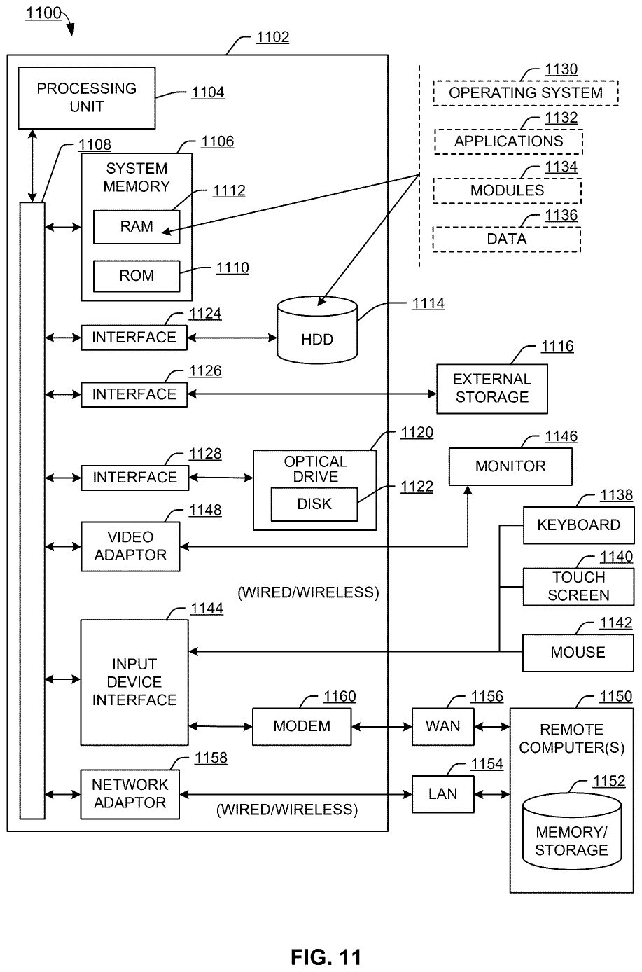

Each of base station 102 and/or UE(s) 104 can be implemented with part(s) of computing environment 1100 of FIG. 11.

A UE of UE(s) 104 can send communications (e.g., hybrid automatic repeat request (HARQ) communications) to base station 102 via a broadband cellular network. Dynamic uplink modification using TTI bundling and DRL component 106 can use real-time measurements of broadband cellular communications with the UE and a DRL agent to determine a configuration for TTI bundling in communications with the UE.

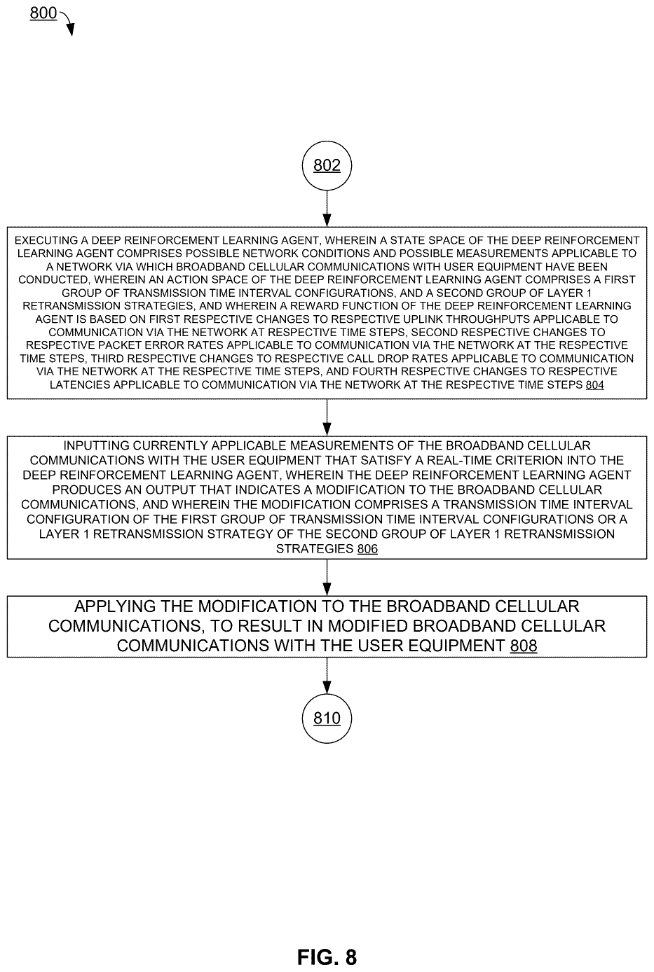

In some examples, dynamic uplink modification using TTI bundling and DRL component 106 can implement part(s) of the process flows of FIGS. 8-10 to implement dynamic uplink modification using TTI bundling and DRL.

It can be appreciated that system architecture 100 is one example system architecture for dynamic uplink modification using TTI bundling and DRL, and that there can be other system architectures that facilitate dynamic uplink modification using TTI bundling and DRL.

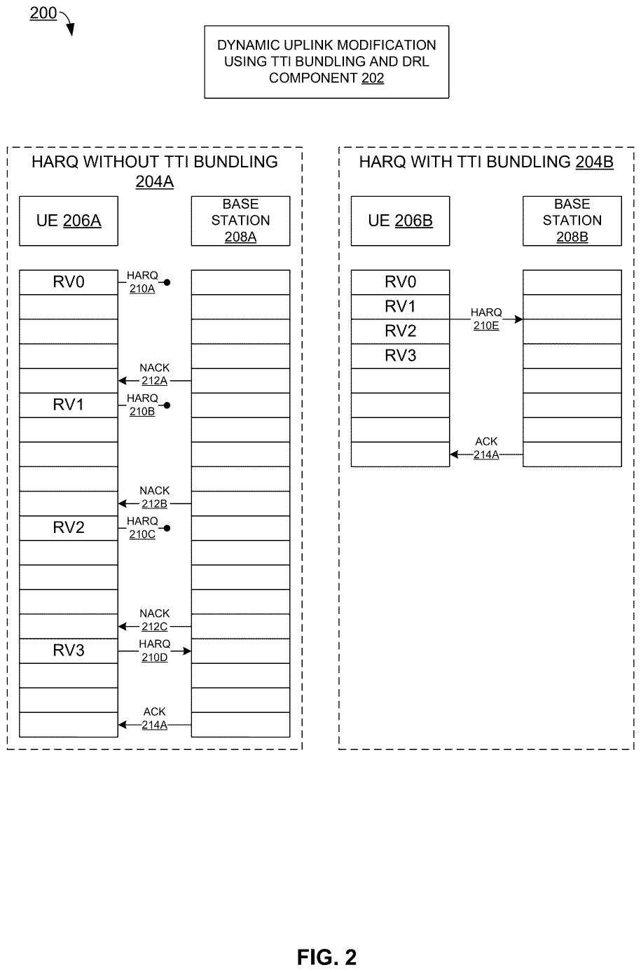

FIG. 2 illustrates an example 200 of transmission time interval (TTI) bundling, and that can facilitate dynamic uplink modification using TTI bundling and DRL, in accordance with an embodiment of this disclosure. In some examples, part(s) of example 200 can be implemented by part(s) of system architecture 100 of FIG. 1 to facilitate dynamic uplink modification using TTI bundling and DRL.

Example 200 comprises dynamic uplink modification using TTI bundling and DRL component 202 (which can be similar to dynamic uplink modification using TTI bundling and DRL component 106 of FIG. 1), HARQ without TTI bundling 204A, HARQ with TTI bundling 204B, UE 206A, UE 206B, base station 208A, base station 208B, HARQ 210A, HARQ 210B, HARQ 210C, HARQ 210D, HARQ 210E, negative acknowledgment (NACK) 212A, NACK 212B, NACK 212C, acknowledgment (ACK) 214A, and ACK 214B.

Compared to HARQ without TTI bundling 204A, HARQ with TTI bundling 204B is more efficient, and this TTI bundling configuration can be determined by dynamic uplink modification using TTI bundling and DRL component 202, to change a configuration from HARQ without TTI bundling 204A to HARQ with TTI bundling 204B.

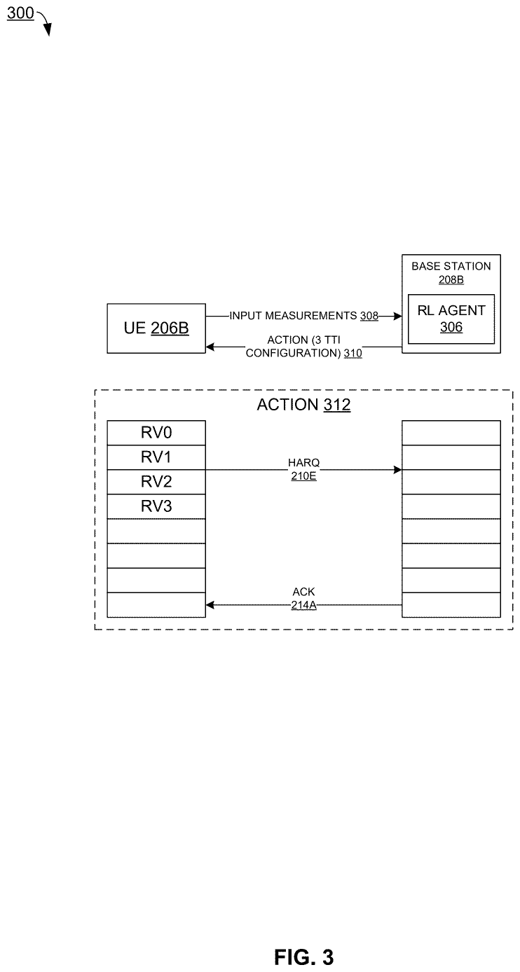

FIG. 3 illustrates an example 300 message flow within a reinforcement learning system, and that can facilitate dynamic uplink modification using TTI bundling and DRL, in accordance with an embodiment of this disclosure. In some examples, part(s) of example 300 can be implemented by part(s) of system architecture 100 of FIG. 1 to facilitate dynamic uplink modification using TTI bundling and DRL.

Example 300 comprises UE 302, base station 304, reinforcement learning agent 306, input measurements 308, action (3 TTI configuration) 310, and action 312.

Reinforcement learning agent 306 can take input measurements 308 for UE 302, and determine an action 310 with respect to TTI configuration. This action can be used for HARQ transmissions, as illustrated in action 312.

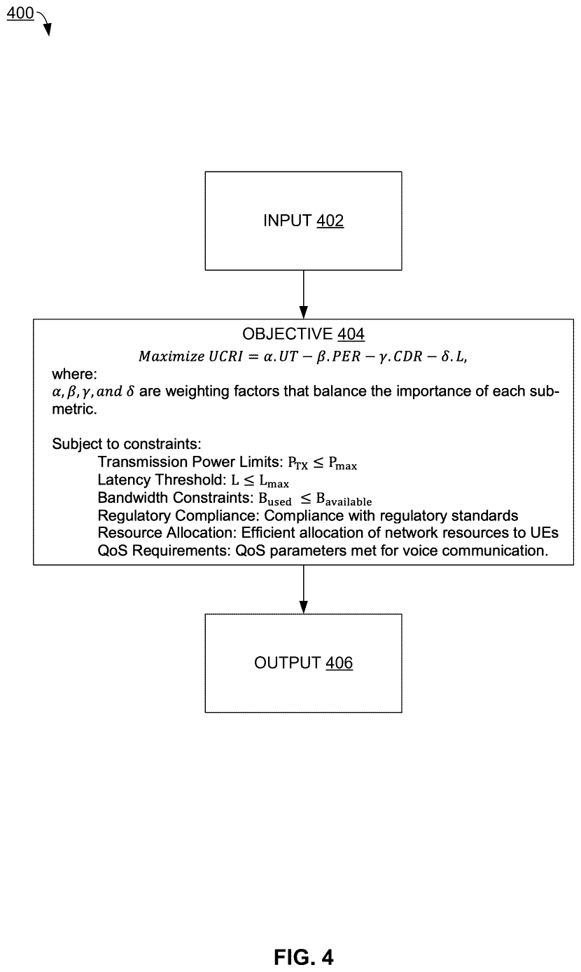

FIG. 4 illustrates an example 400 of an objective, and that can facilitate dynamic uplink modification using TTI bundling and DRL, in accordance with an embodiment of this disclosure. In some examples, part(s) of example 400 can be implemented by part(s) of system architecture 100 of FIG. 1 to facilitate dynamic uplink modification using TTI bundling and DRL.

Example 400 comprises input 402, objective 404, and output 406.

Objective 404 can be formulated to maximize the uplink coverage and reliability index (UCRI), and in the example of FIG. 1, can be implemented by dynamic uplink modification using TTI bundling and DRL component 106.

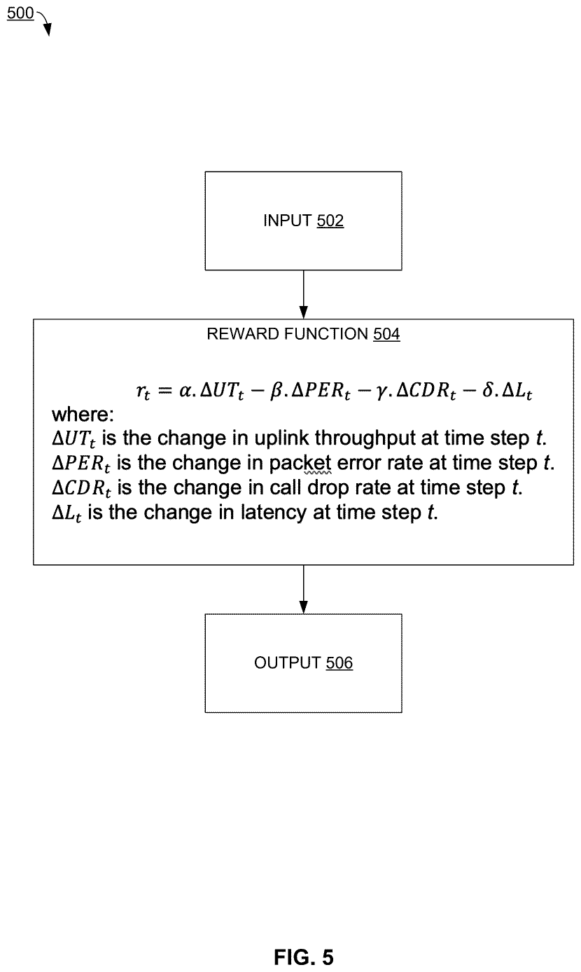

FIG. 5 illustrates an example 500 of a reward function, and that can facilitate dynamic uplink modification using TTI bundling and DRL, in accordance with an embodiment of this disclosure. In some examples, part(s) of example 500 can be implemented by part(s) of system architecture 100 of FIG. 1 to facilitate dynamic uplink modification using TTI bundling and DRL.

Example 500 comprises input 502, reward function 504, and output 506.

Reward function 504 can be formulated to reflect optimization of the UCRI. It can be determined based on the improvements in the sub-metrics (UT, PER, CDR, and L) at each time step.

### Example Process Flows

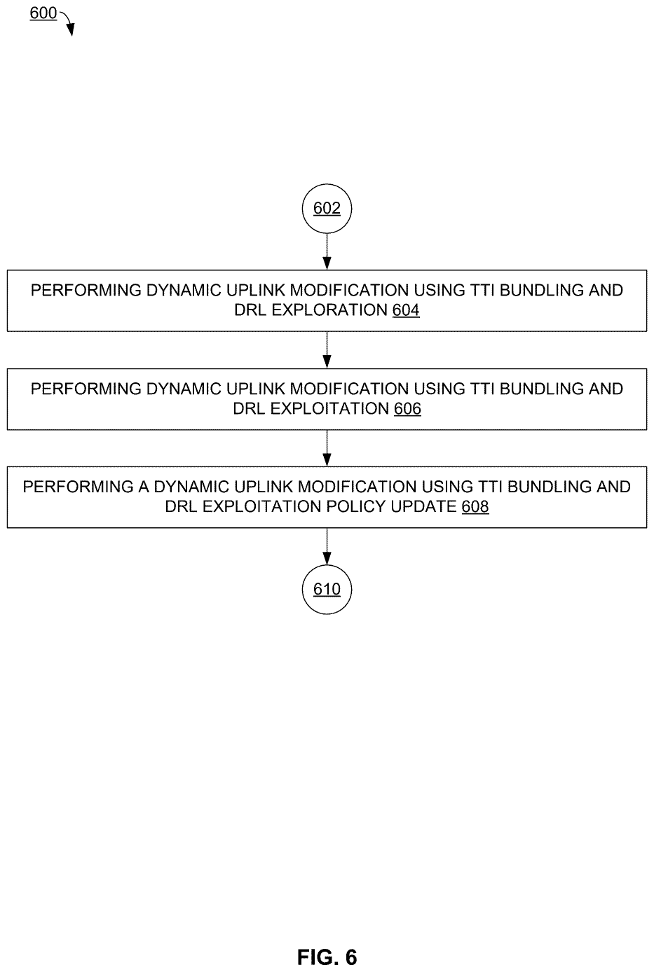

FIG. 6 illustrates an example process flow 600 of a policy update, and that can facilitate dynamic uplink modification using TTI bundling and DRL, in accordance with an embodiment of this disclosure. In some examples, one or more embodiments of process flow 600 can be implemented by dynamic uplink modification using TTI bundling and DRL component 106 of FIG. 1, or computing environment 1100 of FIG. 11.

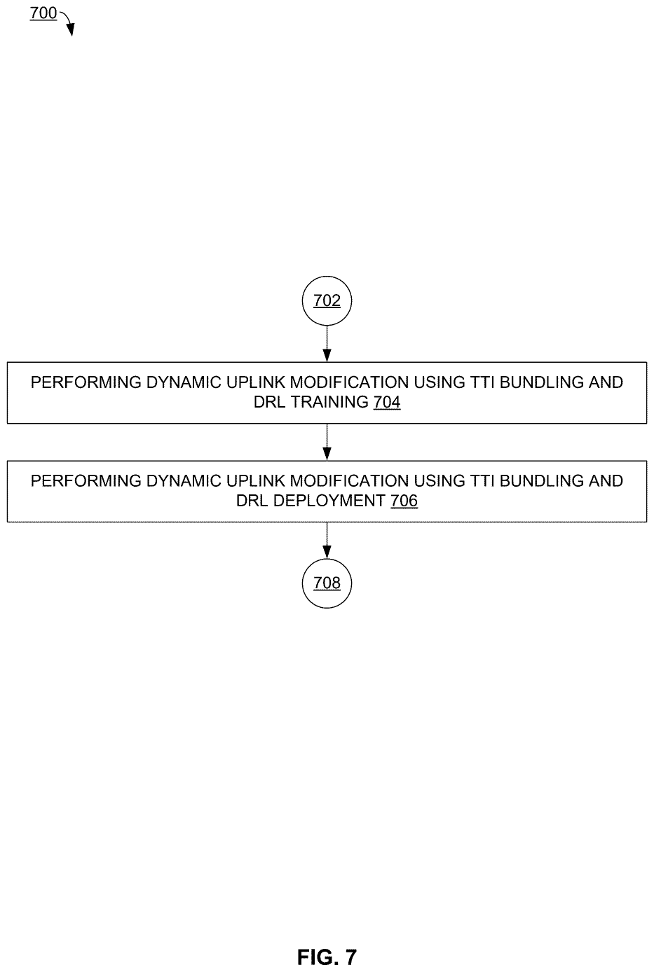

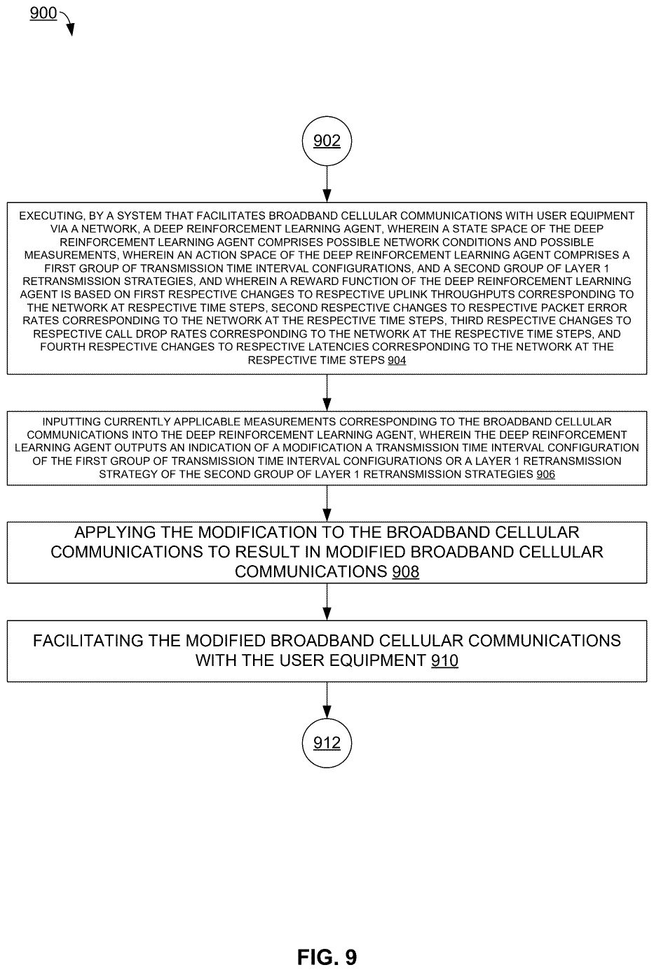

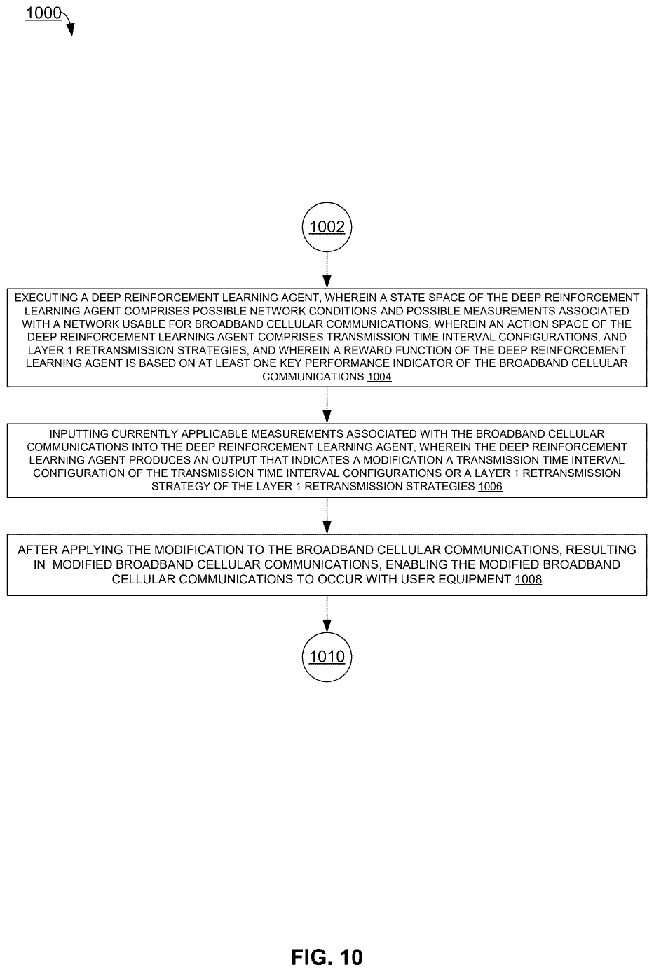

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts performing dynamic uplink modification using TTI bundling and DRL exploration. This can comprise sampling actions from the action space to discover their effects on the state and reward.

After operation 604, process flow 600 moves to operation 606.

Operation 606 depicts performing dynamic uplink modification using TTI bundling and DRL exploitation. This can comprise actions that maximize the expected reward based on the learned policy.

After operation 606, process flow 600 moves to operation 608.

Operation 608 depicts performing a dynamic uplink modification using TTI bundling and DRL policy update. This can comprise adjusting the policy parameters to improve the expected cumulative reward.

After operation 608, process flow 600 moves to 610, where process flow 600 ends.

FIG. 7 illustrates an example process flow 700 of training and deployment, and that can facilitate dynamic uplink modification using TTI bundling and DRL, in accordance with an embodiment of this disclosure. In some examples, one or more embodiments of process flow 700 can be implemented by dynamic uplink modification using TTI bundling and DRL component 106 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 600 of FIG. 6, process flow 800 of FIG. 8, process flow 900 of FIG. 9, and/or process flow 1000 of FIG. 10.

Process flow 700 begins with 702, and moves to operation 704.

Operation 704 depicts performing dynamic uplink modification using TTI bundling and DRL training. That is, the DRL agent can be trained in a simulated network environment that mimics real-world conditions. The agent can explore various TTI configurations, and learn to optimize the KPI through trial and error.

After operation 704, process flow 700 moves to operation 706.

Operation 706 depicts performing dynamic uplink modification using TTI bundling and DRL deployment. That is, once trained, the DRL agent can be deployed in the live network. It can continuously monitor the input measurements and dynamically adjust TTI configurations in real-time to maintain optimal uplink coverage and reliability.

After operation 706, process flow 700 moves to 708, where process flow 700 ends.

FIG. 8 illustrates another example process flow 800 that can facilitate dynamic uplink modification using TTI bundling and DRL, in accordance with an embodiment of this disclosure. In some examples, one or more embodiments of process flow 800 can be implemented by dynamic uplink modification using TTI bundling and DRL component 106 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 600 of FIG. 6, process flow 700 of FIG. 7, process flow 900 of FIG. 9, and/or process flow 1000 of FIG. 10.

Process flow 800 begins with 802, and moves to operation 804.

Operation 804 depicts executing a deep reinforcement learning agent, wherein a state space of the deep reinforcement learning agent comprises possible network conditions and possible measurements applicable to a network via which broadband cellular communications with user equipment have been conducted, wherein an action space of the deep reinforcement learning agent comprises a first group of transmission time interval configurations, and a second group of layer 1 retransmission strategies, and wherein a reward function of the deep reinforcement learning agent is based on first respective changes to respective uplink throughputs applicable to communication via the network at respective time steps, second respective changes to respective packet error rates applicable to communication via the network at the respective time steps, third respective changes to respective call drop rates applicable to communication via the network at the respective time steps, and fourth respective changes to respective latencies applicable to communication via the network at the respective time steps. That is, using the example of FIG. 1, base station 102 can communicate with a UE of UEs 104. Base station 102 can execute a DRL agent that has a particular state space, a particular action space, and a particular reward function, as described herein.

In some examples, the reward function comprises a sum of first respective values that correspond to the first respective changes, second respective values that correspond to the second respective changes, third respective values that correspond to the third respective changes, and fourth respective values that correspond to the fourth respective changes. In some examples, there are a finite number of the respective time steps, which corresponds to a time horizon value. That is, as described above, a DRL agent can learn the optimal policy π* that maximizes the expected cumulative reward R, defined as:

$${π}^{*} = arg max \text{?} [ {\sum }_{t = 0}^{T} {r}_{t} ] ,$$

where:
rₜ is the reward at time step t, which is a function of the KPI, and
T is the time horizon.

In some examples, the possible network conditions and the possible measurements comprise a signal-to-noise ratio measurement applicable to the network, a reference signal received power measurement applicable to the network, a packet error rate measurement applicable to the network, a round-trip time measurement applicable to the network, an interference level measurement applicable to the network, or a retransmission count measurement applicable to the network. That is, a state space of the DRL agent can comprise possible network conditions and measurements, including SNR, RSRP, RSRQ, PER, RTT, user mobility, interference levels, and retransmission count.

In some examples, the reward function comprises a measurement of an uplink coverage and reliability index value applicable to the network. That is, the reward function can reflect an optimization of the UCRI.

In some examples, the reward function is based on a first weighting of first respective values that correspond to the first respective changes, a second weighting of second respective values that correspond to the second respective changes, a third weighting of third respective values that correspond to the third respective changes, and a fourth weighting of fourth respective values that correspond to the fourth respective changes. That is, the reward function can be of the form:

$${r}_{t} = α . Δ {UT}_{t} - β . Δ PE {R}_{t} - γ . Δ CD {R}_{t} - δ . Δ {L}_{t}$$

In some examples, the broadband cellular communications comprise first communications pursuant to a voice over long-term-evolution service or second communications pursuant to a voice over new radio service. That is, the present techniques can be implemented to facilitate VoLTE and/or VoNR services.

After operation 804, process flow 800 moves to operation 806.

Operation 806 depicts inputting currently applicable measurements of the broadband cellular communications with the user equipment that satisfy a real-time criterion into the deep reinforcement learning agent, wherein the deep reinforcement learning agent produces an output that indicates a modification to the broadband cellular communications, and wherein the modification comprises a transmission time interval configuration of the first group of transmission time interval configurations or a layer 1 retransmission strategy of the second group of layer 1 retransmission strategies. That is, real-time measurements can be input into the DRL agent of operation 806 to determine how to modify TTL retransmission and/or a layer 1 retransmission strategy.

After operation 806, process flow 800 moves to operation 808.

Operation 808 depicts applying the modification to the broadband cellular communications, to result in modified broadband cellular communications with the user equipment. That is, the broadband cellular communications can be modified based on the determination of how to modify TTL retransmission and/or a layer 1 retransmission strategy of operation 806, and this can be used for further communications between the base station and the UE.

After operation 808, process flow 800 moves to 810, where process flow 800 ends.

FIG. 9 illustrates an example process flow 900 that can facilitate dynamic uplink modification using TTI bundling and DRL, in accordance with an embodiment of this disclosure. In some examples, one or more embodiments of process flow 900 can be implemented by dynamic uplink modification using TTI bundling and DRL component 106 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 600 of FIG. 6, process flow 700 of FIG. 7, process flow 800 of FIG. 8, and/or process flow 1000 of FIG. 10.

Process flow 900 begins with 902, and moves to operation 904.

Operation 904 depicts executing, by a system that facilitates broadband cellular communications with user equipment via a network, a deep reinforcement learning agent, wherein a state space of the deep reinforcement learning agent comprises possible network conditions and possible measurements, wherein an action space of the deep reinforcement learning agent comprises a first group of transmission time interval configurations, and a second group of layer 1 retransmission strategies, and wherein a reward function of the deep reinforcement learning agent is based on first respective changes to respective uplink throughputs corresponding to the network at respective time steps, second respective changes to respective packet error rates corresponding to the network at the respective time steps, third respective changes to respective call drop rates corresponding to the network at the respective time steps, and fourth respective changes to respective latencies corresponding to the network at the respective time steps. In some examples, operation 904 can be implemented in a similar manner as operation 804 of FIG. 8.

In some examples, the deep reinforcement learning agent implements a deep Q-network process, a proximal policy optimization process, or an advantage actor-critic process.

In some examples, the transmission time interval configuration comprises transmission time interval bundling over a number of consecutive subframes. That is, TTI bundling can comprise a UE transmitting a PUSCH over multiple consecutive subframes, such as a group of four consecutive subframes.

In some examples, the layer 1 retransmission strategy comprises a maximum number of retransmissions of data at a physical layer of the broadband cellular communications. That is, layer 1 retransmissions can comprise repeating a transmission of data at a physical layer to increase an effective transmission time.

After operation 904, process flow 900 moves to operation 906.

Operation 906 depicts inputting currently applicable measurements corresponding to the broadband cellular communications into the deep reinforcement learning agent, wherein the deep reinforcement learning agent outputs an indication of a modification a transmission time interval configuration of the first group of transmission time interval configurations or a layer 1 retransmission strategy of the second group of layer 1 retransmission strategies. In some examples, operation 906 can be implemented in a similar manner as operation 806 of FIG. 8.

In some examples, the modification comprises the transmission time interval configuration, and the layer 1 retransmission strategy. That is, a result of the DRL agent's output can comprise changing both the transmission time interval configuration and the layer 1 retransmission strategy at the same time, or together.

After operation 906, process flow 900 moves to operation 908.

Operation 908 depicts applying the modification to the broadband cellular communications to result in modified broadband cellular communications. In some examples, operation 908 can be implemented in a similar manner as operation 808 of FIG. 8.

After operation 908, process flow 900 moves to operation 910.

Operation 910 depicts facilitating the modified broadband cellular communications with the user equipment. In some examples, operation 910 can be implemented in a similar manner as operation 808 of FIG. 8.

In some examples, operation 910 comprises performing iterations of, inputting a time-series of currently applicable measurements that comprise the currently applicable measurements into the deep reinforcement learning agent to produce respective outputs, and respectively modifying the broadband cellular communications based on the respective outputs, wherein the performing of the iterations results in the modified broadband cellular communications. That is, TTI durations can be dynamically adjusted over time, such as based on real-time network feedback.

In some examples, operation 910 comprises performing iterations of updating the deep reinforcement learning agent based on a time series of the currently applicable measurements corresponding to the broadband cellular communications. That is, a DRL agent can repeatedly refine its decision-making process through interaction with the network environment.

After operation 910, process flow 900 moves to 912, where process flow 900 ends.

FIG. 10 illustrates an example process flow 1000 that can facilitate dynamic uplink modification using TTI bundling and DRL, in accordance with an embodiment of this disclosure. In some examples, one or more embodiments of process flow 1000 can be implemented by dynamic uplink modification using TTI bundling and DRL component 106 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 600 of FIG. 6, process flow 700 of FIG. 7, process flow 800 of FIG. 8, and/or process flow 900 of FIG. 9.

Process flow 1000 begins with 1002, and moves to operation 1004.

Operation 1004 depicts executing a deep reinforcement learning agent, wherein a state space of the deep reinforcement learning agent comprises possible network conditions and possible measurements associated with a network usable for broadband cellular communications, wherein an action space of the deep reinforcement learning agent comprises transmission time interval configurations, and layer 1 retransmission strategies, and wherein a reward function of the deep reinforcement learning agent is based on at least one key performance indicator of the broadband cellular communications. In some examples, operation 1004 can be implemented in a similar manner as operation 804 of FIG. 8.

In some examples, the deep reinforcement learning agent is trained in a simulated environment that is separate from the system, before being deployed to the system. That is, a DRL agent can be trained in a simulated environment that closely mimics real-world network conditions, allowing it to learn effectively before deployment.

In some examples, the reward function is based on a constraint associated with the network, and wherein the constraint comprises a transmission power limit value associated with the network, a latency threshold value associated with the network, a bandwidth constraint value associated with the network, a regulatory compliance value associated with the network, a resource allocation value associated with the network, or a quality of service value associated with the network. That is, there can be constraints for the reward function, as described above.

After operation 1004, process flow 1000 moves to operation 1006.

Operation 1006 depicts inputting currently applicable measurements associated with the broadband cellular communications into the deep reinforcement learning agent, wherein the deep reinforcement learning agent produces an output that indicates a modification a transmission time interval configuration of the transmission time interval configurations or a layer 1 retransmission strategy of the layer 1 retransmission strategies. In some examples, operation 1006 can be implemented in a similar manner as operation 806 of FIG. 8.

After operation 1006, process flow 1000 moves to operation 1008.

Operation 1008 depicts after applying the modification to the broadband cellular communications, resulting in modified broadband cellular communications, enabling the modified broadband cellular communications to occur with user equipment. In some examples, operation 1008 can be implemented in a similar manner as operation 808 of FIG. 8.

In some examples, operation 1008 comprises updating the deep reinforcement learning agent based on sampling actions from the action space, to produce sampled actions, and determining an effect on the state space and the reward function based on the sampled actions, to produce a learned policy.

In some examples, operation 1008 comprises updating the deep reinforcement learning agent based on selecting actions that satisfy a maximization criterion with respect to an expected reward of the reward function, and based on the learned policy.

In some examples, operation 1008 the deep reinforcement learning agent comprises a neural network model that is configured to produce the output, and the updating of the deep reinforcement learning agent comprises adjusting at least one weight or at least one bias of the neural network model.

This can comprise the exploration, exploitation, and policy update of a DRL agent learning algorithm, as described above.

After operation 1008, process flow 1000 moves to 1010, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of base station 102 and/or UE(s) 104.

In some examples, computing environment 1100 can implement one or more embodiments of the process flows of FIGS. 8-10 to facilitate dynamic uplink modification using TTI bundling and DRL.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can also be connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1060 or can be connected to a communications server on the WAN 1156 via other means for establishing communications over the WAN 1156, such as by way of the Internet. The modem 1060, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1060, respectively. Upon connecting the computer 1102 to an associated cloud storage system, the external storage interface 1126 can, with the aid of the adapter 1158 and/or modem 1060, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
executing a deep reinforcement learning agent,
wherein a state space of the deep reinforcement learning agent comprises possible network conditions and possible measurements applicable to a network via which broadband cellular communications with user equipment have been conducted,
wherein an action space of the deep reinforcement learning agent comprises a first group of transmission time interval configurations, and a second group of layer 1 retransmission strategies, and
wherein a reward function of the deep reinforcement learning agent is based on first respective changes to respective uplink throughputs applicable to communication via the network at respective time steps, second respective changes to respective packet error rates applicable to communication via the network at the respective time steps, third respective changes to respective call drop rates applicable to communication via the network at the respective time steps, and fourth respective changes to respective latencies applicable to communication via the network at the respective time steps;
inputting currently applicable measurements of the broadband cellular communications with the user equipment that satisfy a real-time criterion into the deep reinforcement learning agent, wherein the deep reinforcement learning agent produces an output that indicates a modification to the broadband cellular communications, and wherein the modification comprises a transmission time interval configuration of the first group of transmission time interval configurations or a layer 1 retransmission strategy of the second group of layer 1 retransmission strategies; and
applying the modification to the broadband cellular communications, to result in modified broadband cellular communications with the user equipment.

2. The system of claim 1, wherein the reward function comprises a sum of first respective values that correspond to the first respective changes, second respective values that correspond to the second respective changes, third respective values that correspond to the third respective changes, and fourth respective values that correspond to the fourth respective changes.

3. The system of claim 1, wherein there are a finite number of the respective time steps, which corresponds to a time horizon value.

4. The system of claim 1, wherein the possible network conditions and the possible measurements comprise a signal-to-noise ratio measurement applicable to the network, a reference signal received power measurement applicable to the network, a packet error rate measurement applicable to the network, a round-trip time measurement applicable to the network, an interference level measurement applicable to the network, or a retransmission count measurement applicable to the network.

5. The system of claim 1, wherein the reward function comprises a measurement of an uplink coverage and reliability index value applicable to the network.

6. The system of claim 1, wherein the reward function is based on a first weighting of first respective values that correspond to the first respective changes, a second weighting of second respective values that correspond to the second respective changes, a third weighting of third respective values that correspond to the third respective changes, and a fourth weighting of fourth respective values that correspond to the fourth respective changes.

7. The system of claim 1, wherein the broadband cellular communications comprise first communications pursuant to a voice over long-term-evolution service or second communications pursuant to a voice over new radio service.

8. A method, comprising:
executing, by a system comprising a least one processor that facilitates broadband cellular communications with user equipment via a network, a deep reinforcement learning agent,
wherein a state space of the deep reinforcement learning agent comprises possible network conditions and possible measurements,
wherein an action space of the deep reinforcement learning agent comprises a first group of transmission time interval configurations, and a second group of layer 1 retransmission strategies, and
wherein a reward function of the deep reinforcement learning agent is based on first respective changes to respective uplink throughputs corresponding to the network at respective time steps, second respective changes to respective packet error rates corresponding to the network at the respective time steps, third respective changes to respective call drop rates corresponding to the network at the respective time steps, and fourth respective changes to respective latencies corresponding to the network at the respective time steps;
inputting, by the system, currently applicable measurements corresponding to the broadband cellular communications into the deep reinforcement learning agent, wherein the deep reinforcement learning agent outputs an indication of a modification a transmission time interval configuration of the first group of transmission time interval configurations or a layer 1 retransmission strategy of the second group of layer 1 retransmission strategies;
applying, by the system, the modification to the broadband cellular communications to result in modified broadband cellular communications; and
facilitating, by the system, the modified broadband cellular communications with the user equipment.

9. The method of claim 8, wherein the deep reinforcement learning agent implements a deep Q-network process, a proximal policy optimization process, or an advantage actor-critic process.

10. The method of claim 8, wherein the transmission time interval configuration comprises transmission time interval bundling over a number of consecutive subframes.

11. The method of claim 8, wherein the layer 1 retransmission strategy comprises a maximum number of retransmissions of data at a physical layer of the broadband cellular communications.

12. The method of claim 8, further comprising:
performing, by the system, iterations of,
inputting a time-series of currently applicable measurements that comprise the currently applicable measurements into the deep reinforcement learning agent to produce respective outputs, and
respectively modifying the broadband cellular communications based on the respective outputs,
wherein the performing of the iterations results in the modified broadband cellular communications.

13. The method of claim 8, wherein the modification comprises the transmission time interval configuration, and the layer 1 retransmission strategy.

14. The method of claim 8, further comprising:
performing, by the system, iterations of updating the deep reinforcement learning agent based on a time series of the currently applicable measurements corresponding to the broadband cellular communications.

15. A non-transitory computer-readable medium comprising instructions that, in response to execution, cause a system comprising at least one processor to perform operations, comprising:
executing a deep reinforcement learning agent,
wherein a state space of the deep reinforcement learning agent comprises possible network conditions and possible measurements associated with a network usable for broadband cellular communications,
wherein an action space of the deep reinforcement learning agent comprises transmission time interval configurations, and layer 1 retransmission strategies, and
wherein a reward function of the deep reinforcement learning agent is based on at least one key performance indicator of the broadband cellular communications;
inputting currently applicable measurements associated with the broadband cellular communications into the deep reinforcement learning agent, wherein the deep reinforcement learning agent produces an output that indicates a modification a transmission time interval configuration of the transmission time interval configurations or a layer 1 retransmission strategy of the layer 1 retransmission strategies; and
after applying the modification to the broadband cellular communications, resulting in modified broadband cellular communications, enabling the modified broadband cellular communications to occur with user equipment.

16. The non-transitory computer-readable medium of claim 15, wherein the deep reinforcement learning agent is trained in a simulated environment that is separate from the system, before being deployed to the system.

17. The non-transitory computer-readable medium of claim 15, wherein the reward function is based on a constraint associated with the network, and wherein the constraint comprises a transmission power limit value associated with the network, a latency threshold value associated with the network, a bandwidth constraint value associated with the network, a regulatory compliance value associated with the network, a resource allocation value associated with the network, or a quality of service value associated with the network.

18. The non-transitory computer-readable medium of claim 15, wherein the operations further comprise:
updating the deep reinforcement learning agent based on:
sampling actions from the action space, to produce sampled actions, and
determining an effect on the state space and the reward function based on the sampled actions, to produce a learned policy.

19. The non-transitory computer-readable medium of claim 18, wherein the operations further comprise:
updating the deep reinforcement learning agent based on selecting actions that satisfy a maximization criterion with respect to an expected reward of the reward function, and based on the learned policy.

20. The non-transitory computer-readable medium of claim 19, wherein the deep reinforcement learning agent comprises a neural network model that is configured to produce the output, and wherein the updating of the deep reinforcement learning agent comprises:
adjusting at least one weight or at least one bias of the neural network model.
